(19) United States
(12) Patent Application Publication
(10) Pub. No.: US 2023/0122710 A1
(43) Pub. Date: Apr. 20, 2023

(54) HYBRID ELECTRIC VEHICLE

(71) Applicant: TOYOTA JIDOSHA KABUSHIKI KAISHA, Toyota-shi, Aichi-ken (JP)

(72) Inventor: Takahiro KODAMA, (US)

(73) Assignee: TOYOTA JIDOSHA KABUSHIKI KAISHA, Toyota-shi, Aichi-ken (JP)

(21) Appl. No.: 17/931,288

(22) Filed: Sep. 12, 2022

(30) Foreign Application Priority Data
Oct. 14, 2021 (JP) 2021-168711

(51) Int. Cl. B60W 20/16; B60W 10/06

(52) U.S. Cl. CPC B60W 20/16; B60W 10/06; B60W 2710/0694; B60W 2710/0627; B60W 2510/068; B60W 2710/0644

(57) ABSTRACT

A hybrid electric vehicle includes an engine equipped with a filter that removes particulate matter in an exhaust system, a motor for traveling, an electric power storage device that exchanges electric power with the motor, and a control device that controls the engine and the motor. The control device stops, when a predetermined condition is satisfied, rotation of the engine and inhibits, when a filter temperature as a temperature of the filter is equal to or higher than a predetermined temperature, the rotation stop of the engine regardless of whether or not the predetermined condition is satisfied.

### CROSS-REFERENCE TO RELATED APPLICATION

This application claims priority to Japanese Patent Application No. 2021-168711 filed on Oct. 14, 2021, incorporated herein by reference in its entirety.

### BACKGROUND

### 1. Technical Field

The present disclosure relates to a hybrid electric vehicle, and more particularly to a hybrid electric vehicle including an engine, a motor, and an electric power storage device.

### 2. Description of Related Art

In the related art, as a hybrid electric vehicle of this type, a vehicle including an engine, a motor for traveling, and an electric power storage device has been proposed (refer to, for example, Japanese Unexamined Patent Application Publication No. 2018-65448 (JP 2018-65448 A). In this hybrid electric vehicle, the engine is equipped with a filter that removes particulate matter in an exhaust system. The electric power storage device exchanges electric power with the motor. In this hybrid electric vehicle, when a temperature of the filter is equal to or higher than a predetermined temperature, a fuel cut of the engine is inhibited. Since supply of air (oxygen) to the filter is suppressed with this fuel cut, combustion of particulate matter accumulated on the filter is suppressed, and thus overheating of the filter is suppressed.

### SUMMARY

In the hybrid electric vehicle, control of stopping rotation of the engine may be performed when a predetermined condition is satisfied. When the temperature of the filter is equal to or higher than the predetermined temperature and the rotation of the engine is stopped, a decrease in the temperature of the filter is suppressed since exhaust gas of the engine is not supplied to the filter, and thus the filter is maintained in a high temperature state.

A main object of a hybrid electric vehicle of the present disclosure is to suppress a filter being maintained in a high temperature state.

The hybrid electric vehicle of the present disclosure has adopted the following means in order to achieve the above main object.

A hybrid electric vehicle of the present disclosure includes an engine equipped with a filter that removes particulate matter in an exhaust system, a motor for traveling, an electric power storage device that exchanges electric power with the motor, and a control device that controls the engine and the motor.

The control device stops, when a predetermined condition is satisfied, rotation of the engine, and inhibits, when a filter temperature as a temperature of the filter is equal to or higher than a predetermined temperature, the rotation stop of the engine regardless of whether or not the predetermined condition is satisfied.

In the hybrid electric vehicle of the present disclosure, when the predetermined condition is satisfied, the rotation of the engine is stopped. When the filter temperature as the temperature of the filter is equal to or higher than the predetermined temperature, the rotation stop of the engine is inhibited regardless of whether or not the predetermined condition is satisfied. Accordingly, when the filter temperature is equal to or higher than the predetermined temperature, the engine continues to rotate. Thus, the exhaust gas of the engine can be supplied to the filter to cool the filter. As a result, it is possible to suppress the filter being maintained at the high temperature. The term “predetermined condition” is a condition set in advance when the condition is a condition for stopping the rotation of the engine. An example of the predetermined condition includes a condition in which a requested power to be output from the engine is equal to or less than a stop threshold value for stopping an output of the power from the engine. An example of the term “predetermined temperature” includes a threshold value for determining whether or not the filter has a high temperature.

In such a hybrid electric vehicle of the present disclosure, the control device may inhibit, when the filter temperature is equal to or higher than the predetermined temperature, fuel cut of the engine and the rotation stop of the engine. With the above inhibition, it is possible to suppress the combustion of the particulate matter due to the supply of air (oxygen) to the filter by the fuel cut, suppress the temperature rise of the filter, and further suppress the filter being maintained in the high temperature state.

Further, in the hybrid electric vehicle of the present disclosure, the control device may permit, when the rotation stop of the engine is inhibited and the filter temperature becomes equal to or lower than an execution permitted temperature less than the predetermined temperature, the rotation stop of the engine. With the above permission, it is possible to stop the rotation of the engine when the temperature of the filter is sufficiently lowered. An example of the “execution permitted temperature” includes a temperature at which the rotation stop of the engine can be permitted since the filter does not reach the high temperature state even though the rotation of the engine is stopped.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram showing an outline of a configuration of a hybrid electric vehicle 20 as an example of the present disclosure;

FIG. 2 is a flowchart showing an example of a rotation stop permission/rejection routine executed by an HVECU 70 of the example; and

FIG. 3 is a diagram for describing an example of time changes in on/off of an accelerator pedal 83, an inhibition flag Finh, and a filter temperature Tf.

### DETAILED DESCRIPTION OF EMBODIMENTS

Next, an embodiment for carrying out the present disclosure will be described with reference to examples.

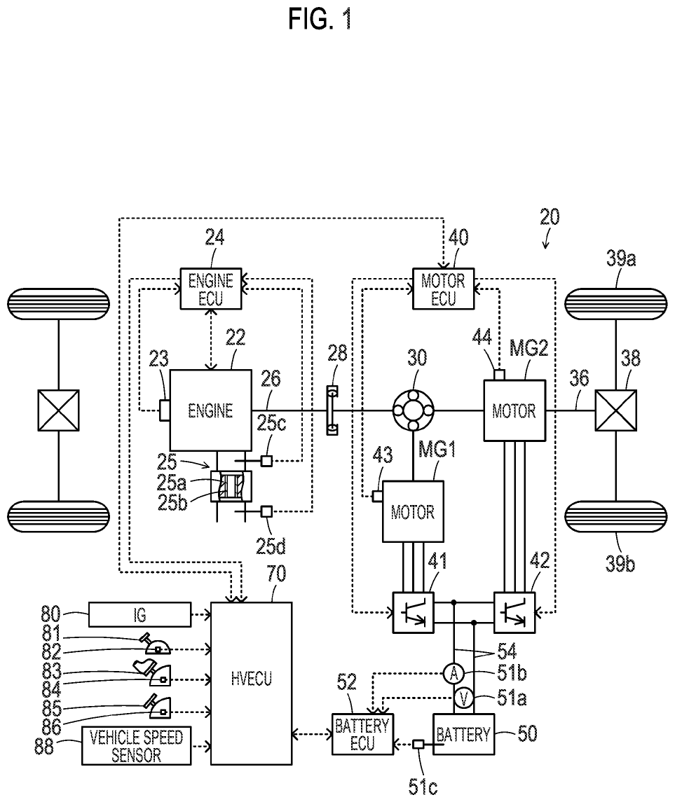

FIG. 1 is a configuration diagram showing an outline of a configuration of a hybrid electric vehicle 20 as an example of the present disclosure. As shown in the figure, the hybrid electric vehicle 20 of the example includes an engine 22, a planetary gear 30, motors MG1, MG2, inverters 41, 42, a battery 50 as an electric power storage device, and an electronic control unit for hybrid electric vehicle (hereinafter referred to as “HVECU”) 70.

The engine 22 is configured as an internal combustion engine that outputs power using gasoline, light oil, or the like as fuel. A particulate matter removal filter (hereinafter referred to as “PM filter”) 25 is attached to an exhaust system of the engine 22. The PM filter 25 is integrally formed by attaching (coating) a catalyst 25b having a noble metal to a porous base material 25a made of ceramics, stainless steel, or the like to remove particulate matter (PM) such as soot in exhaust gas and also remove unburned fuel and a nitrogen oxide. The engine 22 is operated and controlled by an electronic control unit for engine (hereinafter referred to as “engine ECU”) 24.

Although not shown, the engine ECU 24 is configured as a microprocessor centered on a CPU and includes a ROM that stores a processing program, a RAM that temporarily stores data, an input/output port, and a communication port in addition to the CPU. The engine ECU 24 receives signals from various sensors requested for controlling the operation of the engine 22 via the input port. Examples of the signal input to the engine ECU 24 may include a crank angle θcr from a crank position sensor 23 that detects a rotation position of a crankshaft 26 and a coolant temperature Tw from a water temperature sensor (not shown) that detects a temperature of a coolant of the engine 22. Further, a throttle opening degree TH from a throttle valve position sensor (not shown) that detects a position of a throttle valve, an intake air amount Qa from an air flow meter (not shown) attached to an intake pipe, and an intake air temperature Ta from a temperature sensor (not shown) attached to the intake pipe may be also included in the above examples of the signal. Furthermore, pressures P1, P2 from pressure sensors 25c, 25d attached to an upstream side and a downstream side of the PM filter 25 of the exhaust system may be also included in the above examples of the signal. The engine ECU 24 outputs various control signals for controlling the operation of the engine 22 via the output port. Examples of the signal output from the engine ECU 24 may include a drive control signal to a throttle motor to adjust the position of the throttle valve, a drive control signal to a fuel injection valve, and a drive control signal to an ignition coil integrated with an igniter. The engine ECU 24 is connected to the HVECU 70 via the communication port. The engine ECU 24 calculates a speed Ne of the engine 22 based on the crank angle θcr from the crank position sensor 23. Further, the engine ECU 24 also calculates a volumetric efficiency (ratio of volume of actual intake air in one cycle to a stroke volume per cycle of the engine 22) KL based on the intake air amount Qa from the air flow meter and the speed Ne of the engine 22. Furthermore, the engine ECU 24 calculates (estimates) a PM accumulation amount Qpm as an accumulation amount of the particulate matter accumulated on the PM filter 25 based on a differential pressure ΔP (ΔP=P1−P2) of the pressures P1, P2 from the pressure sensors 25c, 25d or calculates (estimates) a filter temperature Tf as a temperature of the PM filter 25 based on an operation state (speed Ne and volumetric efficiency KL) of the engine 22.

The planetary gear 30 is configured as a single-pinion planetary gear mechanism. A rotor of the motor MG1 is connected to a sun gear of the planetary gear 30. A drive shaft 36 connected to drive wheels 39a, 39b via a differential gear 38 is connected to a ring gear of the planetary gear 30. The crankshaft 26 of the engine 22 is connected to a carrier of the planetary gear 30 via a damper 28.

The motor MG1 is configured as, for example, a synchronous generator motor, and as described above, the rotor thereof is connected to the sun gear of the planetary gear 30. The motor MG2 is configured as, for example, the synchronous generator motor, and a rotor thereof is connected to the drive shaft 36. The inverters 41, 42 are connected to the motors MG1, MG2 and are connected to the battery 50 via electric power lines 54. An electronic control unit for motor (hereinafter referred to as “motor ECU”) 40 performs switching control on a plurality of switching elements (not shown) of the inverters 41, 42 to rotationally drive the motors MG1, MG2.

Although not shown, the motor ECU 40 is configured as a microprocessor centered on a CPU and includes a ROM that stores a processing program, a RAM that temporarily stores data, an input/output port, and a communication port in addition to the CPU. The motor ECU 40 receives, via the input port, signals from various sensors requested for driving and controlling the motors MG1, MG2, for example, rotation positions θm1, θm2 from rotation position detection sensors 43, 44 that detect rotation positions of the rotors of the motors MG1, MG2 and a phase current from a current sensor that detects a current flowing in each phase of the motors MG1, MG2. The motor ECU 40 outputs switching control signals and the like to the switching elements (not shown) of the inverters 41, 42 via the output port. The motor ECU 40 is connected to the HVECU 70 via the communication port. The motor ECU 40 calculates speeds Nm1, Nm2 of the motors MG1, MG2 based on the rotation positions θm1, θm2 of the rotors of the motors MG1, MG2 from the rotation position detection sensors 43, 44.

The battery 50 is configured as, for example, a lithium ion secondary battery or a nickel hydrogen secondary battery and is connected to the inverters 41, 42 via the electric power lines 54. The battery 50 is managed by an electronic control unit for battery (hereinafter referred to as “battery ECU”) 52.

Although not shown, the battery ECU 52 is configured as a microprocessor centered on a CPU and includes a ROM that stores a processing program, a RAM that temporarily stores data, an input/output port, and a communication port in addition to the CPU. The battery ECU 52 receives signals from various sensors requested for managing the battery 50 via the input port. Examples of the signal input to the battery ECU 52 include a voltage Vb of the battery 50 from a voltage sensor 51a installed between terminals of the battery 50, a current Ib of the battery 50 from a current sensor 51b attached to the output terminal of the battery 50, and a temperature Tb of the battery 50 from a temperature sensor 51c attached to the battery 50. The battery ECU 52 is connected to the HVECU 70 via the communication port. The battery ECU 52 calculates an electric power storage ratio SOC based on an integrated value of the current lb of the battery 50 from the current sensor 51b or input/output limits Win, Wout based on the calculated electric power storage ratio SOC and the temperature Tb of the battery 50 from the temperature sensor 51c. The electric power storage ratio SOC is a ratio of a capacity of electric power that can be discharged from the battery 50 to a total capacity of the battery 50. The input/output limits Win, Wout are allowable charge/discharge electric power that may charge/discharge the battery 50.

Although not shown, the HVECU 70 is configured as a microprocessor centered on a CPU and includes a ROM that stores a processing program, a RAM that temporarily stores data, an input/output port, and a communication port in addition to the CPU. The HVECU 70 receives signals from various sensors via the input port. Examples of the signal input to the HVECU 70 may include an ignition signal from an ignition switch 80 and a shift position SP from a shift position sensor 82 that detects an operation position of a shift lever 81. Further, an accelerator operation amount Acc from an accelerator pedal position sensor 84 that detects a depressed amount of an accelerator pedal 83, a brake pedal position BP from a brake pedal position sensor 86 that detects the depressed amount of a brake pedal 85, and a vehicle speed V from a vehicle speed sensor 88 may be also included in the examples of the signal. As described above, the HVECU 70 is connected to the engine ECU 24, the motor ECU 40, and the battery ECU 52 via the communication port.

The hybrid electric vehicle 20 of the example configured in this manner travels in a hybrid traveling mode (HV traveling mode) in which the vehicle travels along with the rotation (fuel cut during operation or rotation) of the engine 22 or an electric traveling mode (EV traveling mode) in which the vehicle travels along with a rotation stop (operation stop) of the engine 22.

In the HV traveling mode, the following travel control is basically performed by cooperative control of the HVECU 70, the engine ECU 24, and the motor ECU 40. The HVECU 70 sets requested torque Td* requested for traveling (requested for drive shaft 36) based on the accelerator operation amount Acc and the vehicle speed V, multiplies the set requested torque Td* by a speed Nd of the drive shaft 36 (speed Nm2 of motor MG2) to calculate requested power Pd* requested for traveling (requested for drive shaft 36), and subtracts charge/discharge requested power Pb* (a positive value when discharged from the battery 50) based on the electric power storage ratio SOC of the battery 50 from the requested power Pd* to calculate requested power Pe* requested for the vehicle (requested for engine 22). Subsequently, a target speed Ne* and target torque Te* of the engine 22 and torque commands Tm1*, Tm2* of the motors MG1, MG2 are set such that the requested power Pe* is output from the engine 22 and the requested torque Td* is output to the drive shaft 36 within a range of the input/output limits Win, Wout of the battery 50. Then, the target speed Ne* and target torque Te* of the engine 22 are transmitted to the engine ECU 24, and the torque commands Tm1*, Tm2* of the motors MG1, MG2 are transmitted to the motor ECU 40. When the target speed Ne* and target torque Te* of the engine 22 are received, the engine ECU 24 performs intake air amount control, fuel injection control, ignition control, and the like of the engine 22 such that the engine 22 is operated, based on the target speed Ne* and the target torque Te*. When the torque commands Tm1*, Tm2* of the motors MG1, MG2 are received, the motor ECU 40 performs the switching control on the switching elements of the inverters 41, 42 such that the motors MG1, MG2 are driven by the torque commands Tm1 *, Tm2*. In the HV traveling mode, when a stop condition (predetermined condition) of the engine 22 such as when the requested power Pe* reaches a threshold value for stop Pstop or less, the threshold value being set as an upper limit of a range of the requested power Pe* at which the operation of the engine 22 is better to be stopped, or when the electric power storage ratio SOC reaches a threshold value SOCmax or more, the threshold value being set in advance as an upper limit of the electric power storage ratio SOC at which the charge of the battery 50 is better to be stopped, is satisfied, the operation of the engine 22 is stopped (the rotation of the engine 22 is stopped) and the traveling mode shifts to the EV traveling mode.

In the EV traveling mode, the following travel control is basically performed by cooperative control of the HVECU 70, the engine ECU 24, and the motor ECU 40. The HVECU 70 sets the requested torque Td* based on the accelerator operation amount Acc and the vehicle speed V, sets a value of 0 in the torque command Tm1* of the motor MG1, sets the torque command Tm2* of the motor MG2 such that the requested torque Td* is output to the drive shaft 36 within the range of the input/output limits Win, Wout of the battery 50, and transmits the torque commands Tm1*, Tm2* of the motors MG1, MG2 to the motor ECU 40. The control of the inverters 41, 42 by the motor ECU 40 has been described above. In the EV traveling mode, as in the HV traveling mode, when a start condition of the engine 22 such as when the calculated requested power Pe* reaches a threshold value for start Pstart or more, the threshold value being set as a lower limit of the range of the requested power Pe* at which the engine 22 is better to be started, is satisfied, the engine 22 is started and the traveling mode shifts to the HV traveling mode.

When the accelerator pedal 83 is turned off and the filter temperature Tf as the temperature of the PM filter 25 is less than a threshold value Tfref 1, the hybrid electric vehicle 20 of the example permits the fuel cut of the engine 22 to perform the fuel cut that stops fuel injection from the fuel injection valve. The threshold value Tfref 1 is a temperature at which the filter temperature Tf may rise to an overheating temperature Tfot or more due to combustion of the particulate matter when the fuel cut of the engine 22 is performed and air (oxygen) is supplied to the PM filter 25, is a temperature slightly lower than the overheating temperature Tfot, and is set to, for example, 890° C., 900° C., 910° C., or the like. The overheating temperature Tfot is the filter temperature Tf at which determination can be made that the PM filter 25 is overheated and is a temperature at which some abnormality (for example, damage to base material 25a or catalyst 25b) may occur in the PM filter 25. With the permission of the fuel cut of the engine 22 in this manner, when the accelerator pedal 83 is turned off, the fuel injection of the engine 22 is stopped (fuel cut is performed) and air (oxygen) is supplied to the PM filter 25 to combust the particulate matter accumulated on the PM filter 25. With the combustion, the PM filter 25 is regenerated. When the fuel cut of the engine 22 is performed, the engine 22 may be motorized by the motor MG1.

When the accelerator pedal 83 is turned off and the filter temperature Tf is equal to or higher than the threshold value Tfref 1, the fuel cut of the engine 22 is inhibited and the fuel injection is performed from the fuel injection valve (load operation or idle operation is performed). Accordingly, it is possible to suppress that the filter temperature Tf reaches the threshold value Tfref 1 or higher. As a result, the overheating of the PM filter 25 is suppressed, and the PM filter 25 (base material 25a and catalyst 25b) is more protected.

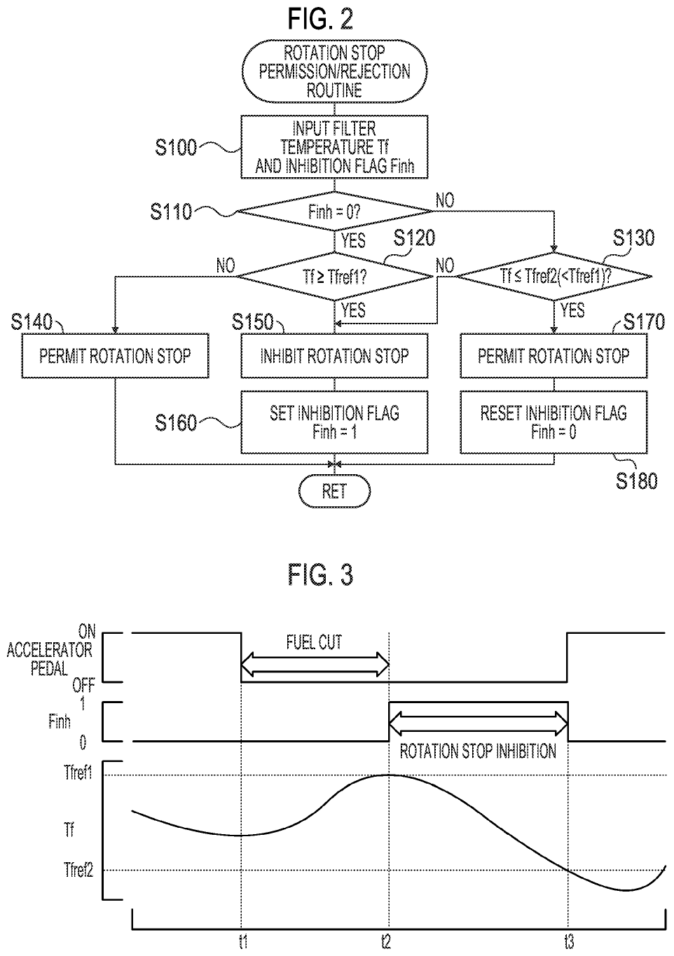

Next, an operation of the hybrid electric vehicle 20 of the example configured in this manner, particularly an operation when the PM filter 25 needs to be regenerated will be described. FIG. 2 is a flowchart showing an example of a rotation stop permission/rejection routine executed by the HVECU 70 of the example. The present routine is repeatedly executed when the PM accumulation amount Qpm is equal to or higher than a threshold value Qpmref and the filter temperature Tf is equal to or higher than a regenerable temperature Tfreg.

The PM accumulation amount Qpm is calculated (estimated) based on the differential pressure ΔP (ΔP=P1−P2) of the pressures P1, P2 from the pressure sensors 25c, 25d and is input from the engine ECU 24 by communication. The filter temperature Tf is calculated (estimated) based on the operation state of the engine 22 and is input from the engine ECU 24 by communication. The threshold value Qpmref is a PM accumulation amount Qpm with which determination can be made that the PM filter 25 needs to be regenerated. The regenerable temperature Tfreg is a temperature at which the PM filter 25 can be regenerated and is set to, for example, 490° C., 500° C., 510° C., or the like.

When the present routine is executed, the HVECU 70 first inputs the filter temperature Tf as the temperature of the PM filter 25 and the inhibition flag Finh (step S100). The filter temperature Tf is calculated (estimated) based on the operation state of the engine 22 and is input from the engine ECU 24 by communication. The inhibition flag Finh is a flag indicating whether or not to inhibit a rotation stop of the engine 22. The inhibition flag Finh is set to a value of 0 as an initial value, is set to a value of 1 in step S160 described below, and is set to the value of 0 in step S180.

When the data is input in this manner, determination is made whether or not the inhibition flag Finh has the value of 0 (step S110). When the inhibition flag Finh has the value of 0, that is, when the rotation stop of the engine 22 is not inhibited (rotation stop is permitted), subsequently, determination is made whether or not the filter temperature Tf input in step S100 is equal to or higher than the threshold value Tfref 1 (step S120).

When the filter temperature Tf is less than the threshold value Tfref 1 in step S120, the rotation stop of the engine 22 is permitted (step S140), and the present routine ends. With the permission of the rotation stop of the engine 22 in this manner, when the stop condition (predetermined condition) of the engine 22 is satisfied, the operation of the engine 22 is stopped (rotation of engine 22 is stopped) and the traveling mode may shift to the EV traveling mode.

When the filter temperature Tf is equal to or higher than the threshold value Tfref 1 in step S120, the rotation stop of the engine 22 is inhibited (step S150), the value of 1 is set to the inhibition flag Finh (step S160), and the present routine ends. With the inhibition of the rotation stop of the engine 22 in this manner, in the HV traveling mode, the engine 22 is continuously operated (rotation of engine 22 is not stopped) even when the stop condition (predetermined condition) of the engine 22 is satisfied. Accordingly, it is possible to supply the exhaust gas of the engine 22 to the PM filter 25 and thus cool the PM filter 25 with the unburned fuel contained in the exhaust gas. Therefore, it is possible to suppress that the filter temperature Tf of the PM filter 25 is maintained in a high temperature state of the threshold value Tfref 1 or higher.

When the inhibition flag Finh has the value of 1 in step S110, that is, when the rotation stop of the engine 22 is inhibited and the inhibition flag Finh is set to the value of 1 in steps S150, S160, subsequently, determination is made whether or not the filter temperature Tf input in step S100 is equal to or lower than a threshold value Tfref 2 (execution permitted temperature) lower than the threshold value Tfref 1 (step S130). The threshold value Tfref 2 is a filter temperature Tf at which the rotation stop of the engine 22 can be permitted since the PM filter 25 does not reach the high temperature state even though the rotation of the engine 22 is stopped and is set to, for example, 500° C., 550° C., 600° C., or the like.

When the filter temperature Tf exceeds the threshold value Tfref 2 in step S130, determination is made that the PM filter 25 reaches the high temperature state when the rotation of the engine 22 is stopped, the rotation stop of the engine 22 is inhibited (step S150), the value of 1 is set to the inhibition flag Finh (step S160), and the present routine ends. With the inhibition of the rotation stop of the engine 22 in this manner, in the HV traveling mode, the engine 22 is continuously operated (rotation of engine 22 is not stopped) even when the stop condition (predetermined condition) of the engine 22 is satisfied. Accordingly, it is possible to supply the exhaust gas of the engine 22 to the PM filter 25 and thus cool the PM filter 25 with the unburned fuel contained in the exhaust gas. Therefore, it is possible to suppress that the filter temperature Tf of the PM filter 25 reaches the high temperature state of the threshold value Tfref 1 or higher.

When the filter temperature Tf is equal to or less than the threshold value Tfref 2 in step S130, determination is made that the PM filter 25 does not reach the high temperature state even though the rotation of the engine 22 is stopped, the rotation stop of the engine 22 is permitted (step S170), the value of 0 is set to the inhibition flag Finh (inhibition flag Finh is reset) (step S180), and the present routine ends. With the permission of the rotation stop of the engine 22 in this manner, the operation of the engine 22 can be stopped (rotation of engine 22 can be stopped) when the stop condition (predetermined condition) of the engine 22 is satisfied.

FIG. 3 is a diagram for describing an example of time changes in on/off of the accelerator pedal 83, the inhibition flag Finh, and the filter temperature Tf. When the inhibition flag Finh has the value of 0 and the accelerator pedal 83 is turned off, the fuel cut is performed and air (oxygen) is supplied to the PM filter 25 to combust the particulate matter accumulated on the PM filter 25. Accordingly, the filter temperature Tf rises (time t1 to t2).

When the filter temperature Tf becomes the threshold value Tfref 1 or more, the fuel cut of the engine 22 is inhibited and the fuel injection from the fuel injection valve is performed (load operation or idle operation is performed) (time t2 to t3). In this case, since the inhibition flag Finh is set to the value of 1 to inhibit the stop (rotation stop) of the engine 22, the engine 22 is continuously operated (rotation of engine 22 is not stopped) even when the stop condition (predetermined condition) of the engine 22 is satisfied. Accordingly, the exhaust gas of the engine 22 is supplied to the PM filter 25 to cool the PM filter 25 with the unburned fuel contained in the exhaust gas, and thus the filter temperature Tf is lowered. Therefore, it is possible to suppress that the filter temperature Tf of the PM filter 25 reaches the high temperature state of the threshold value Tfref 1 or higher.

When the filter temperature Tf becomes equal to or less than the threshold value Tfref 2, the inhibition flag Finh is set to the value of 0 to permit the rotation stop of the engine 22 (time t3). Accordingly, when the stop condition (predetermined condition) of the engine 22 is satisfied, the operation of the engine 22 can be stopped (rotation of engine 22 is stopped).

With the hybrid electric vehicle 20 of the above-described example, when the stop condition (predetermined condition) of the engine 22 is satisfied, the rotation of the engine 22 is stopped. When the filter temperature Tf is equal to or higher than the threshold value Tfref 1 (predetermined temperature), the rotation stop of the engine 22 is inhibited regardless of whether or not the stop condition of the engine 22 is satisfied, and thus it is possible to suppress the PM filter 25 being maintained in the high temperature state.

Further, when the filter temperature Tf is equal to or higher than the threshold value Tfref 1, the fuel cut of the engine 22 is inhibited and the rotation stop of the engine 22 is inhibited, and thus it is possible to further suppress the filter being maintained in the high temperature state.

Furthermore, when the rotation stop of the engine 22 is inhibited and the filter temperature Tf becomes equal to or less than the threshold value Tfref 2 (execution permitted temperature) less than the threshold value Tfref 1 (predetermined temperature), the rotation stop of the engine 22 is permitted, and thus it is possible to suppress the temperature rise of the filter.

In the hybrid electric vehicle 20 of the example, when the filter temperature Tf is equal to or higher than the threshold value Tfref 1, the fuel cut of the engine 22 is inhibited. However, when the filter temperature Tf is different from the threshold value Tfref 1, the fuel cut of the engine 22 may be inhibited.

In the hybrid electric vehicle 20 of the example, when the inhibition flag Finh has the value of 1 and the filter temperature Tf is equal to or less than the threshold value Tfref 2 in steps S110, S130, S170, S180 of FIG. 2, the rotation stop of the engine 22 is permitted and the inhibition flag Finh is reset to the value of 0. However, when the filter temperature becomes less than Tfref 1 in step S120, the processing may proceed to step S140 to permit the rotation stop without executing steps S110, S130, S170, S180.

In the hybrid electric vehicle 20 of the example, the PM filter 25 is integrally formed by attaching the catalyst 25b for exhaust gas cleaning to the base material 25a for removing the particulate matter. However, the PM filter may be formed to remove the particulate matter, and a cleaning device having a catalyst for exhaust gas cleaning may be provided separately from the PM filter (on upstream side or downstream side of PM filter in exhaust system of engine 22).

In the hybrid electric vehicle 20 of the example, the battery 50 is used as the electric power storage device, but a capacitor may be used.

The hybrid electric vehicle 20 of the example includes the engine ECU 24, the motor ECU 40, the battery ECU 52, and the HVECU 70, but at least a part of the above components may be configured as a single electronic control unit.

In the example, the present disclosure is applied to the hybrid electric vehicle 20 in which the engine 22 and the motor MG1 are connected to the drive shaft 36 connected to the drive wheels 39a, 39b via the planetary gear 30, the motor MG2 is connected to the drive shaft 36, and the electric power is exchanged between the motors MG1, MG2 and the battery 50. However, the present disclosure may be applied to a hybrid electric vehicle having any configuration as long as the vehicle is a hybrid electric vehicle including an engine, a motor for traveling, and an electric power storage device that exchanges electric power with the motor. For example, the present disclosure may be applied to a hybrid electric vehicle in which a motor is connected to a drive shaft connected to drive wheels via a transmission, an engine is connected to the motor via a clutch, and electric power is exchanged between the motor and a battery. In addition, the present disclosure may be applied to a so-called series hybrid electric vehicle in which a motor for traveling is connected to a drive shaft connected to drive wheels, a generator is connected to an output shaft of an engine, and electric power is exchanged between the generator or the motor and a battery.

A correspondence between the main elements of the example and the main elements of the disclosure described in a column of means for solving the problem will be described. In the example, the engine 22 corresponds to “engine”, the motor MG2 corresponds to “motor”, the battery 50 corresponds to “electric power storage device”, and the engine ECU 24, the motor ECU 40, and the HVECU 70 correspond to “control device”.

The correspondence between the main elements of the example and the main elements of the disclosure described in the column of means for solving the problem is an example for specifically describing the embodiment in which the example carries out the present disclosure described in the column of means for solving the problem and thus does not limit the elements of the disclosure described in the column of means for solving the problem. That is, the interpretation of the disclosure described in the column of means for solving the problem is requested to be performed based on the description in the column, and the example is merely a specific example of the disclosure described in the column of means for solving the problem.

Although the embodiment for carrying out the present disclosure has been described with reference to the example, the present disclosure is not limited to the example, and various embodiments may be carried out within the scope of the gist of the present disclosure.

The present disclosure can be used for specialized manufacturing of the hybrid electric vehicle and the like.

What is claimed is:

1. a hybrid electric vehicle comprising:
an engine equipped with a filter that removes particulate matter in an exhaust system;
a motor for traveling;
an electric power storage device that exchanges electric power with the motor; and
a control device that controls the engine and the motor,
wherein the control device
stops, when a predetermined condition is satisfied, rotation of the engine, and
inhibits, when a filter temperature as a temperature of the filter is equal to or higher than a predetermined temperature, the rotation stop of the engine regardless of whether or not the predetermined condition is satisfied.

2. The hybrid electric vehicle according to claim 1, wherein the control device inhibits, when the filter temperature is equal to or higher than the predetermined temperature, fuel cut of the engine and the rotation stop of the engine.

3. The hybrid electric vehicle according to claim 1, wherein the control device permits, when the rotation stop of the engine is inhibited and the filter temperature becomes equal to or lower than an execution permitted temperature less than the predetermined temperature, the rotation stop of the engine.
